(19) United States
(12) Patent Application Publication
(10) Pub. No.: US 2006/0220503 A1
(43) Pub. Date: Oct. 5, 2006

(54) LOCKING SYSTEM FOR TOP BOX MOUNTED ON ROLL-AWAY CABINET

(75) Inventor: Scott Widrig, Ashville, NY (US)

Correspondence Address: HAHN LOESER & PARKS, LLP, One GOJO Plaza, Suite 300, AKRON, OH, 44311-1076, US

(73) Assignee: MECHANICS CUSTOM TOOLS CORPORATION, Christiana, DE (US)

(21) Appl. No.: 11/306,839

(22) Filed: Jan. 12, 2006

Related U.S. Application Data
(60) Provisional application No. 60/647,882, filed on Jan. 28, 2005.

(51) Int. Cl. E05B 53/00

(52) U.S. Cl. 312/218

(57) ABSTRACT

A locking system for a roll-away cabinet add-on such as a top box that integrates with the existing locking mechanism of the roll-away such that the drawers of the top box are automatically locked and unlocked when the drawers of the roll-away cabinet are locked and unlocked and wherein the top box does not need its own individual locking system.

This application claims the benefit of U.S. Provisional patent application Ser. No. 60/647,882, filed Jan. 28, 2005, and hereby incorporated by reference.

### TECHNICAL FIELD

The present invention relates to a locking system for a roll-away cabinet that utilizes a top box or the like mounted thereon, and more particularly, to a locking system for a roll-away cabinet add-on that integrates with the existing locking mechanism of the roll-away such that the drawers of the add-on are automatically locked and unlocked when the drawers of the roll-away cabinet are locked and unlocked.

### BACKGROUND OF THE INVENTION

Roll-away cabinets are often supplemented with an add-on such as a tool chest or top box. These add-ons typically require their own locking system requiring an additional key. The additional key takes extra time to find the key and open the add-on. Alternatively, the lock of the top box and the cabinet must be keyed the same to require only one key. This still requires the user to open and close each unit individually. As this creates an additional burden for the user, it would be advantageous to provide an add-on that integrated itself with the locking mechanism of the roll-away cabinet.

### SUMMARY OF THE INVENTION

The present invention overcomes at least one problem associated with the prior art by providing a top box comprising a housing; at least one drawer positioned in the housing and extendable therefrom; at least one vertical lock bar moveable between a first position locking the drawer in the housing and a second position releasing the drawer such that the at least one drawer can be extended from the housing; wherein a portion of the at least one vertical lock bar extends from a bottom of the housing and is engageable with an existing vertical lock bar of a roll-away cabinet.

At least one advantage is also provided by a tool storage device comprising: a first housing having at least one first housing drawer extendable therefrom and at least one first housing locking bar positionable in a first position allowing the first housing drawer to be extended from the first housing and a second position locking the first housing drawer within the first housing; a second housing having at least one second housing drawer extendable therefrom and at least one second housing locking bar positionable in a first position allowing the at least one second housing drawer to be extended from the second housing and a second position locking the second housing drawer within the first housing; wherein the first housing is positioned on top of the second housing such that a bottom of the at least one first housing locking bar registers against a top portion of the at least one second housing locking bar such that movement of the second housing locking bar causes movement of the first housing locking bar.

At least one advantage is also provided by, in combination, a top box and a roll-away cabinet comprising; a roll-away housing mounted on a plurality of wheels; a plurality of drawers mounted in the roll-away housing and extendable therefrom; a roll-away housing locking system comprising a vertical lock bar moveable between a first position locking the plurality of drawers in the roll-away housing and a second position releasing the plurality of drawers such that it can be extended from the roll-away housing; a top box housing mounted on top of the roll-away cabinet; at least one top box drawer positioned in the top box housing and extendable therefrom; at least one vertical top box lock bar moveable between a first position locking the top box drawer in the top box housing and a second position releasing the top box drawer such that the top box drawer can be extended from the topbox housing; wherein a portion of the at least one vertical top box lock bar extends from the bottom of the top box housing and into the housing of the roll-away cabinet and is engageable with the vertical lock bar of the roll-away cabinet such that locking system of the roll-away cabinet locks and un-locks the top box.

These and other advantages will be apparent upon a review of the drawings and detailed description of the invention.

### BRIEF DESCRIPTION OF THE DRAWINGS

This invention will now be described in further detail with reference to the accompanying drawings, in which:

FIG. 1 is a perspective view of a roll-away cabinet with a top box mounted thereon;

FIG. 2 is a front view of a roll-away cabinet with a top box mounted thereon;

FIG. 3 is a side view of a roll-away cabinet with a top box mounted thereon;

FIG. 4 is a perspective view of a roll-away cabinet without a top box mounted thereon and with all drawers removed from the cabinet and top box;

FIG. 5 is a detail perspective view of an access hole for the lock bar of the roll-away cabinet;

FIG. 6 is a perspective view of a top box lock bar;

FIG. 7 is a top view of the top box lock bar of FIG. 6;

FIG. 8 is an end view of the top box lock bar of FIG. 6;

FIG. 9 is an side view of the top box lock bar of FIG. 6;

FIG. 10 is a perspective view of a top box;

FIG. 11 is a top view of the top box of FIG. 10;

FIG. 12 is a front view of the top box of FIG. 10;

FIG. 13 is side view of the top box of FIG. 10;

FIG. 14 is a back view of the roll-away cabinet with a top box mounted thereon with a cut-away view of the assembly in the locked condition;

FIG. 15 is a cut-away detail view of the locking system of the present invention as shown in FIG. 14;

FIG. 16 is a back view of the roll-away cabinet with a top box mounted thereon with a cut-away view of the assembly in the un-locked condition;

FIG. 17 is a cut-away detail view of the locking system of the present invention as shown in FIG. 16;

FIG. 18 is a partial perspective detail view of the locking system of the present invention; and

FIG. 19 is a different partial perspective view showing additional elements of the locking system.

### DETAILED DESCRIPTION OF THE DRAWINGS

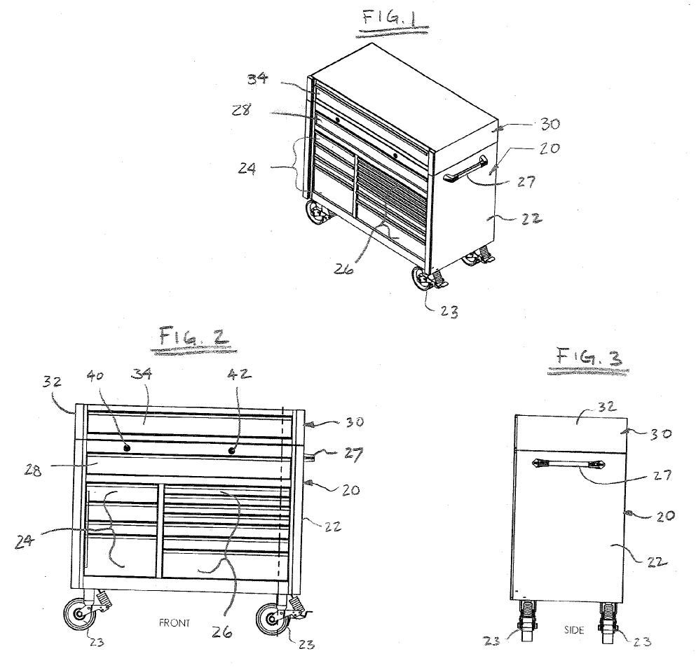

Referring now to FIGS. 1-3, a roll-away cabinet 20 is shown having a top box 30 attached thereto with bolts or other known fastening means (not shown) in accordance with the present invention. The roll-away cabinet 20 is a standard tool cabinet comprising a housing 22 that is mounted on a plurality of wheels 23. The cabinet 20 has a first set of drawers 24 and a second set of drawers 26 each having a plurality of drawers vertically positioned over top of each other. A single, full-width drawer 28 is positioned vertically over the first and second sets of drawers 24, 26. A handle 27 is attached to one end of the roll-away cabinet 20. The top box 30 comprises a housing 32 and at least one, full-width drawer 34 similar to drawer 28. The roll-away cabinet 20 further comprises a pair of locking cylinders 40, 42 shown positioned in the housing 22 to lock the drawers 24, 26, 28 of the roll-away cabinet 20 and the drawer 34 of the top box 30 as discussed below.

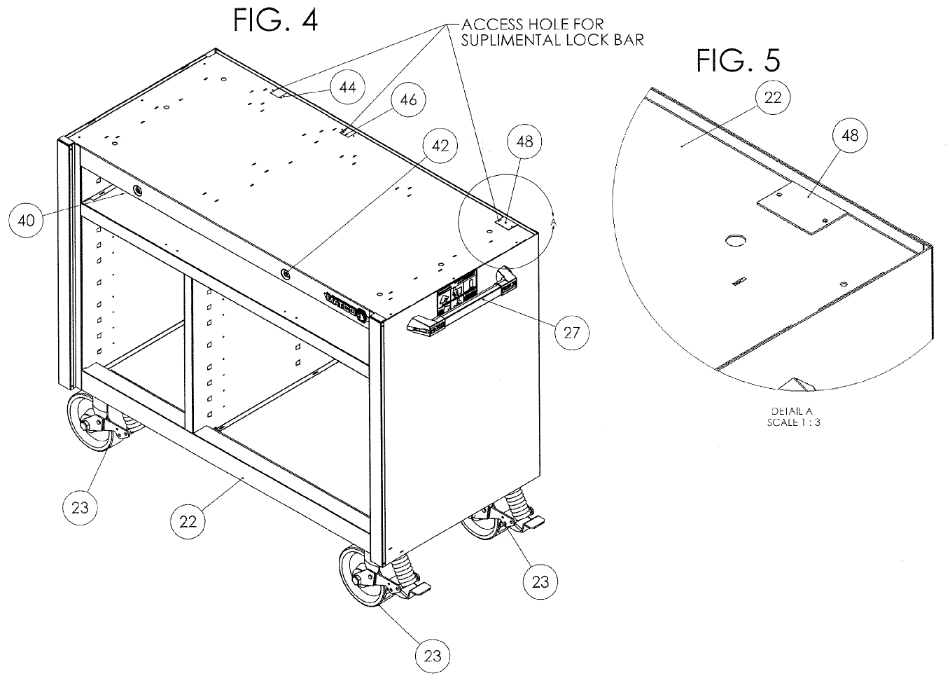

The roll-away cabinet 20 is shown with the drawers removed in FIG. 4 and with the top box 30 removed. The top of the roll-away cabinet 20 has three access holes 44, 46, 48 that are used to install vertical locking bars (not shown) for the roll-away cabinet 20 as is known in the art to lock the drawers 24, 26, 28. The first locking cylinder 40 is associated with the locking bar associated with access hole 44 which locks and unlocks the first set of drawers 24 as well as full-width drawer 28. The second locking cylinder 42 is associated with the locking bars associated with access holes 46 and 48 which lock and unlock the second set of drawers 26 as well as full width drawer 28. The access holes 44, 46, 48 are initially covered by a cover plate that is riveted to the housing when the access holes are not needed (such as when the top box is not used). A close-up of a covered access hole 48 is shown in FIG. 5.

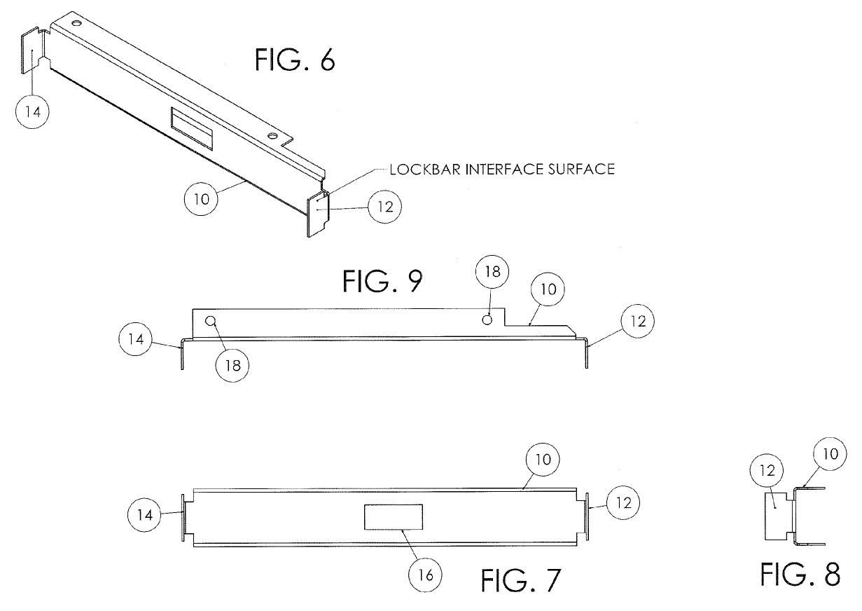

Referring now to FIGS. 6-9 a top box lock bar 10 of the present invention is shown in various views. The lock bar 10 comprises a first end 12 that provides an interface surface to engage a corresponding surface on the roll-away lock bar (not shown). The lock bar 10, as shown, is symmetrical, having a second end 14 that is generally the same as the first end such that the lock bar 10 can be inserted into the top box 30 from either end. The lock bar 10 further comprises an aperture 16 shown herein as a rectangular through hole 16. Additional apertures 18 are shown on either side of aperture 16. These apertures 16 provide an attachment location for biasing means such as springs etc.

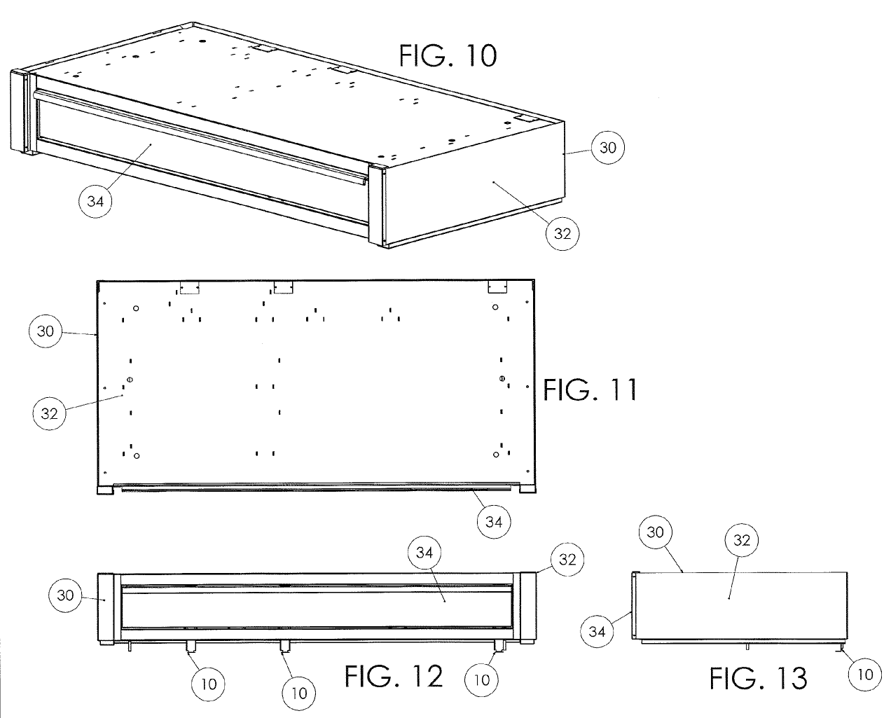

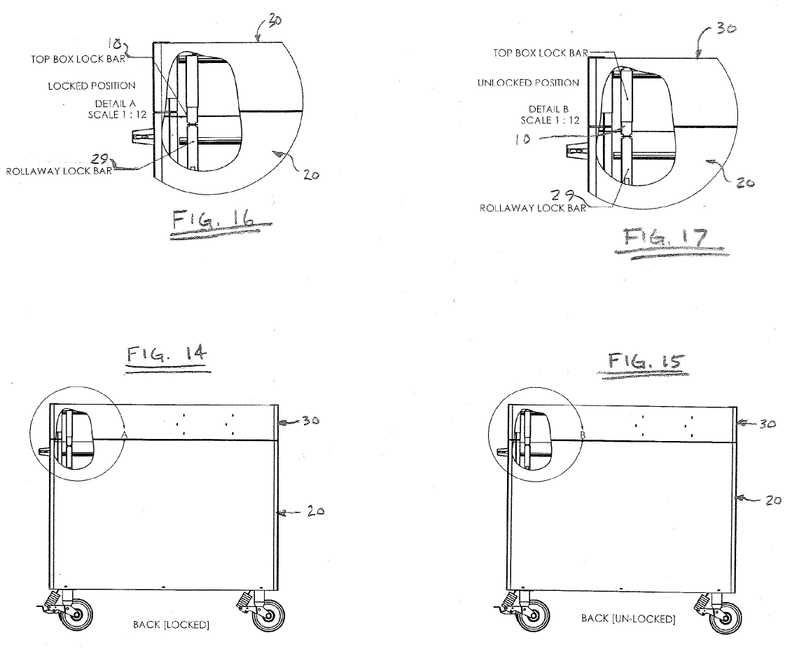

The top box 30 is shown in FIGS. 10-13. The top box comprises a housing 32 and a full width drawer 34. As best shown in FIGS. 12 and 13, three lock bars 10 are shown extending from the bottom of the top box 30. The top box 30 also comprises a plurality of access holes on the top of the top box 30 for inserting the top box lock bars and for allowing more than one top box to be stacked one on top of the other such that all of the top boxes are locked and unlocked by the locking system of the roll-away cabinet.

The operation of the locking system of the present invention is best shown in FIGS. 14-18. The portion of the rear of the roll-away cabinet and top box is removed in FIGS. 14 and 15 with corresponding detail views in FIGS. 15 (locked) and 16 (un-locked). Lock bar 10 of the top box 40 extends through the opening at the top of the roll-away cabinet and engages a roll-away lock bar 29. A lock tab (not shown) on the back of the drawers 26, 28, 34 is engaged by lock bars 29, 10, locking the drawers 26, 28, 34 in the cabinet 20 and top box 30. To unlock the drawers 26, 28, 34, a key (not shown) is inserted into the cylinder 42 and rotated. This causes a bent bar (not shown) in the roll-away cabinet 20 to lift the associated lock bars 29 of the roll-away cabinet 20 and to disengage the lock tab on the back of the drawers 26, 28 thereby releasing the drawers 26, 28. The lock bar 29 in turn lifts lock bar 10 of the top box 30 causing the lock tab on the back of the drawer 34 to disengage thereby releasing the drawer 34.

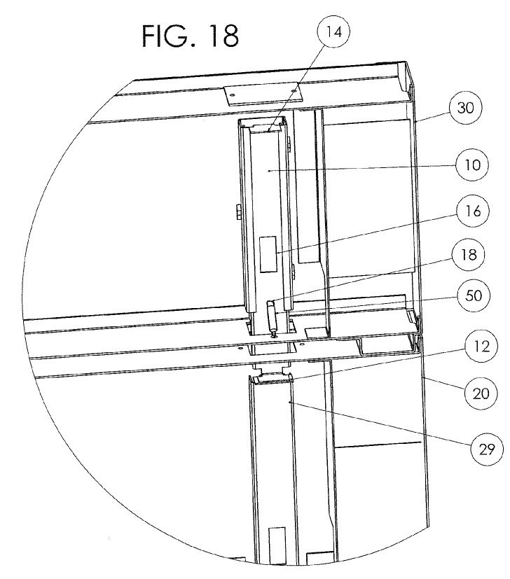

A detail perspective view of the locking mechanism is shown in FIG. 18. A spring 50 is shown attached to the bottom of the top box housing 32 and engaging aperture 18 of the lock bar 10 such that the first end 12 of the lock bar 10 is held against a corresponding surface of the lock bar 29 of the roll-away 20.

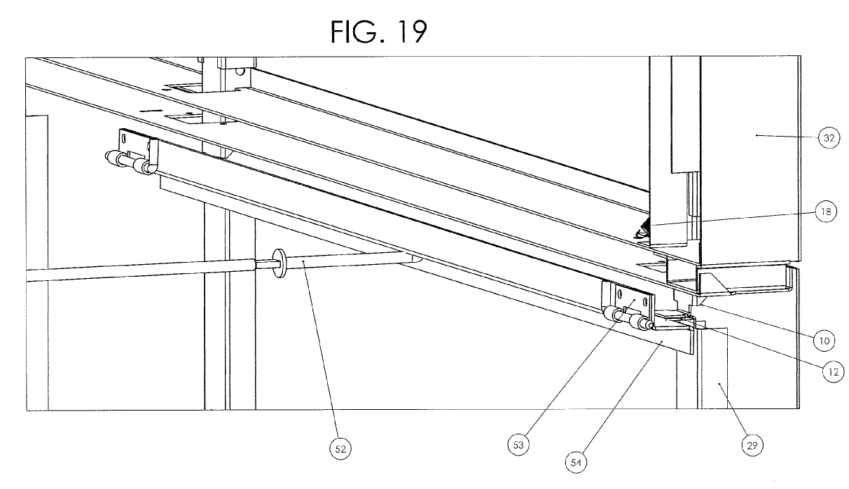

An additional perspective view of the locking system is shown in FIG. 19 that shows the lock rod 52, lock actuator hinge 53 and lock actuator 54. The lock rod 52 is a generally straight with a bent end that engages the lock actuator 54. When the lock rod 52 is rotated, the bent end of the lock rod 52 causes the lock actuator 54 to rotate about lock actuator hinge 53, in turn, raising the lock bar 29 of the roll-away and the lock bar 10 of the top box 30. When the lock rod 52 is rotated back to its original position, the bent end of the lock rod 52 allows the lock actuator 54 to rotate about lock actuator hinge 53, in turn, allowing the lock bar 29 of the roll-away and the lock bar 10 of the top box 30 to be lowered to their original position.

Although the present invention has been described above in detail, the same is by way of illustration and example only and is not to be taken as a limitation on the present invention.

What is claimed is:

1. A tool storage device comprising:
a first housing having at least one first housing drawer extendable therefrom and at least one first housing locking bar positionable in a first position allowing the first housing drawer to be extended from the first housing and a second position locking the first housing drawer within the first housing;
a second housing having at least one second housing drawer extendable therefrom and at least one second housing locking bar positionable in a first position allowing the at least one second housing drawer to be extended from the second housing and a second position locking the second housing drawer within the first housing;
wherein the first housing is positioned on top of the second housing such that a bottom of the at least one first housing locking bar registers against a top portion of the at least one second housing locking bar such that movement of the second housing locking bar causes movement of the first housing locking bar.

2. The tool storage device of claim 1, wherein a portion of the at least one first housing locking bar extends into the second housing.

3. The tool storage device of claim 1 further comprising a key locking mechanism positioned within the second cabinet and adapted to move the at least one second housing locking bar and the at least one first housing locking bar.

4. The tool storage device of claim 3, wherein the first cabinet does not have a key locking mechanism.

5. The tool storage device of claim 1 further comprising a plurality of first housing locking bars, each of the first housing locking bars being selectively positionable in a first position allowing the first housing drawer to be extended from the first housing and a second position locking the first housing drawer within the first housing.

6. The tool storage device of claim 5 further comprising a plurality of second housing locking bars, each of the second housing locking bars being selectively positionable in a first position allowing the at least one second housing drawer to be extended from the second housing and a second position locking the at least one second housing drawer within the second housing.

7. The tool storage device of claim 6 further comprising a plurality of key locking mechanisms positioned within the second cabinet and each adapted to move at least one of the plurality of second housing locking bars and at least one of the plurality of first housing locking bars.

8. The tool storage device of claim 1, wherein the second housing further comprises a removable access panel above a top end of the second housing lock bar that allows the first housing lock bar to extend into the second housing and engage the second housing lock bar such that movement of the second housing lock bar causes movement of the first housing lock bar.

9. The tool storage device of claim 1 further comprising a third housing having at least one third housing drawer extendable therefrom and at least one third housing locking bar positionable in a first position allowing the third housing drawer to be extended from the third housing and a second position locking the third housing drawer within the first housing;
wherein the third housing is positioned on top of the first housing such that a bottom of the at least one third housing locking bar extends into the first housing and registers against a top portion of the at least one first housing locking bar.

10. The tool storage device of claim 9, wherein the first housing further comprises a removable access panel above a top end of the first housing lock bar that allows the third housing lock bar to extend into the first housing and engage the first housing lock bar such that movement of the first housing lock bar causes movement of the third housing lock bar.

11. The tool storage device of claim 10 further comprising a means for biasing the first housing lock bar in the first position.

12. The tool storage device of claim 11, wherein the means for biasing the first housing lock bar in the first position is a spring mounted at a first spring end to the first housing and at a second spring end to the first housing lock bar.

13. A top box comprising:
a housing;
at least one drawer positioned in the housing and extendable therefrom;
at least one vertical lock bar moveable between a first position locking the drawer in the housing and a second position releasing the drawer such that the at least one drawer can be extended from the housing,
wherein a portion of the at least one vertical lock bar extends from a bottom of the housing and is engageable with an existing vertical lock bar of a roll-away cabinet.

14. The top box of claim 13, wherein the top box does not have a key locking mechanism.

15. The top box of claim 13 further comprising a plurality of vertical lock bars, each of the plurality of vertical lock bars being selectively positionable in a first position allowing the at least one drawer to be extended from the housing and a second position locking the at least one drawer within the housing.

16. The top box of claim 13 further comprising a means for biasing the vertical lock bar in the first position.

17. The top box of claim 16, wherein the means for biasing the vertical lock bar in the first position is a spring mounted at a first end to the housing and at a second end to the vertical lock bar.

18. The top box of claim 13, wherein the housing further comprises a removable access panel above a top end of the vertical lock bar that allows a vertical lock bar of a second top box mounted on the top box to extend into the housing and engage the vertical lock bar of the top box.

19. In combination, a top box and a roll-away cabinet comprising;
a roll-away housing mounted on a plurality of wheels;
a plurality of drawers mounted in the roll-away housing and extendable therefrom;
a roll-away housing locking system comprising a vertical lock bar moveable between a first position locking the plurality of drawers in the roll-away housing and a second position releasing the plurality of drawers such that it can be extended from the roll-away housing;
a top box housing mounted on top of the roll-away cabinet;
at least one top box drawer positioned in the top box housing and extendable therefrom;
at least one vertical top box lock bar moveable between a first position locking the top box drawer in the top box housing and a second position releasing the top box drawer such that the top box drawer can be extended from the topbox housing,
wherein a portion of the at least one vertical top box lock bar extends from the bottom of the top box housing and into the housing of the roll-away cabinet and is engageable with the vertical lock bar of the roll-away cabinet such that locking system of the roll-away cabinet locks and un-locks the top box.

20. The combination top box and a roll-away cabinet of claim 19, wherein the top box does not have a key locking mechanism.
